(19) United States
(12) Patent Application Publication
(10) Pub. No.: US 2006/0122967 A1
(43) Pub. Date: Jun. 8, 2006

(54) Intelligent information dissemination using a dynamic user profile

(75) Inventors: Debashish Purkayastha, Pottstown, PA (US); John Thommana, Austin, TX (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/282,414

(22) Filed: Nov. 18, 2005

Related U.S. Application Data
(60) Provisional application No. 60/630,871, filed on Nov. 24, 2004.

(51) Int. Cl. G06F 17/30

(52) U.S. Cl. 707/2

(57) ABSTRACT

A method for distributing information to a user of an information system via a device begins by selecting a user profile. Information is received at the device and is filtered with the selected user profile. The filtered information is displayed to the user.

### CROSS REFERENCE TO RELATED APPLICATION

This application claims the benefit of U.S. Provisional Application No. 60/630,871, filed Nov. 24, 2004, which is incorporated by reference as if fully set forth herein.

### FIELD OF INVENTION

The present invention generally relates to wireless communication systems, and more particularly, to distributing information to a wireless device based on a dynamic user profile.

### BACKGROUND

Information is valuable only when it is delivered to a user at the right time, at the right place, and is useful in fulfilling the user's information needs. Redundant or delayed information can be useless and a source of irritation.

Currently, information delivery can be categorized as subscription-based, location-based, or “junk”-based. For example, a user can subscribe to a news delivery service, which may or may not have subtopic selection criteria. All users subscribing to this service will receive the same information content at the same time. For example, a user accessing a travel Web site in a particular area is presented with coupons or content concerning nearby attractions, restaurants, etc.

Most of these services are based on surveys and are targeted to appeal to general audiences. For example, even though a user is interested in college basketball news, he may have to subscribe to sports news and receive all sports news—most of which the user may not care about. The user also may receive the same information from multiple sources. The information the user is looking for is likely to be embedded in a sea of other information, such that looking for the desired information is not worthwhile.

Since information delivery is not personalized and adaptive, even timely information may be overlooked. There is a need for delivering useful information to a user or a set of users, which is context based, personalization aware, and timely.

### SUMMARY

A method for distributing information to a user of an information system via a device begins by selecting a user profile. Information is received at the device and is filtered with the selected user profile. The filtered information is displayed to the user.

A wireless device for distributing information to a user of an information system includes at least one user profile, a receiver, an information processing entity, and a display. The receiver is configured to receive information from the information system. The information processing entity is configured to select a user profile and to filter the received information with the selected user profile. The display is configured to display the filtered information to the user.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a tree diagram of a user profile;

FIG. 2 is a flowchart of a method for filtering information based on a user profile;

FIG. 3 is a tree diagram of a user profile including a role-based template; and

FIG. 4 is a block diagram of a wireless device for filtering information based on a user profile.

### DETAILED DESCRIPTION OF THE PREFERRED EMBODIMENTS

Hereafter, the term “wireless device” includes, but is not limited to, a wireless transmit/receive unit, a user equipment, a mobile station, a fixed or mobile subscriber unit, a pager, or any other type of device capable of operating in a wireless environment. When referred to hereafter, the term “base station” includes, but is not limited to, a Node B, a site controller, an access point, or any other type of interfacing device in a wireless environment.

The present invention delivers information based on a Personal User Profile (PUP). A PUP is a dynamic filtered tree-like information representation structure, with the information stored in the leaves of the PUP tree. A user-configurable information filter displays personalized and timely information to the user. Since access to all information is available at all times, the user can dynamically change his viewing filter to view additional or extended information from a single sources or from multiple sources.

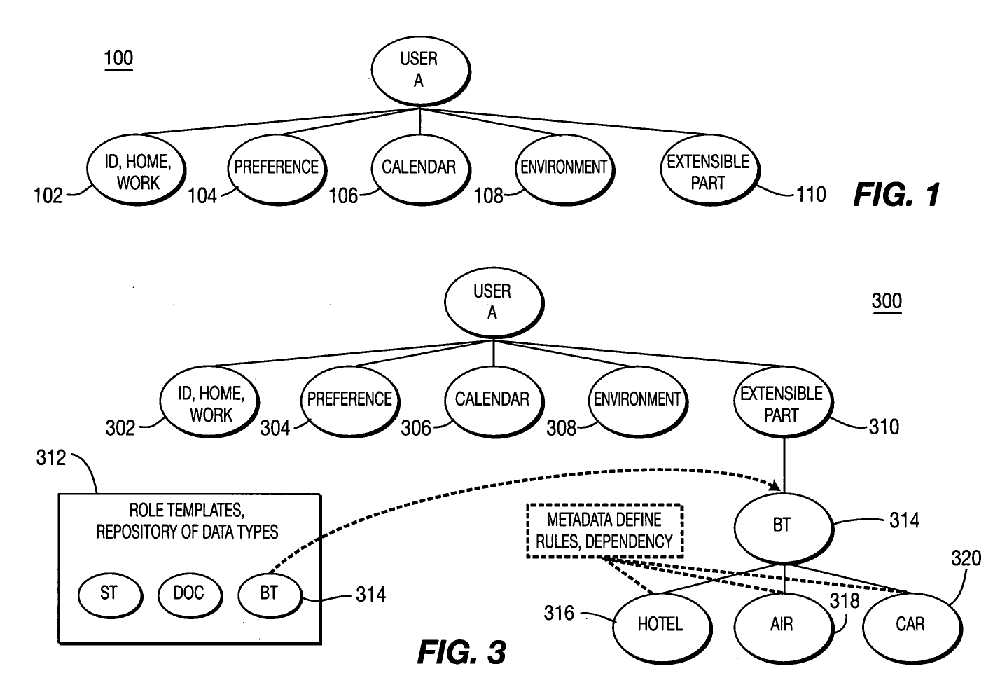

The branches and nodes of the PUP tree have weighted metadata associated with the information. The weights assigned to the information are preference, context, usage, and command based. For example, User A may have a profile 100 as shown in FIG. 1. The profile 100 includes a plurality of individual profiles 102, global preferences 104, a calendar 106, environment settings 108, and an extensible part 110. The extensible part 110 is used to apply specific, role-based templates, which can be linked to the root of another tree depending on user behavior, user preference, or group preference.

The user profile 100 contains information about a particular user and is organized as a tree-like data structure. Depending on the user's current context such as location, proximity, etc. (as determined through the environment settings 108), a portion of the profile 100 can be activated and used to deliver information to the user which will be useful at that point in time. The profile 100 (or a portion of it) can be thought as a filter to pass on information to the user. The user profile 100 can be stored on a network server or on the user's device.

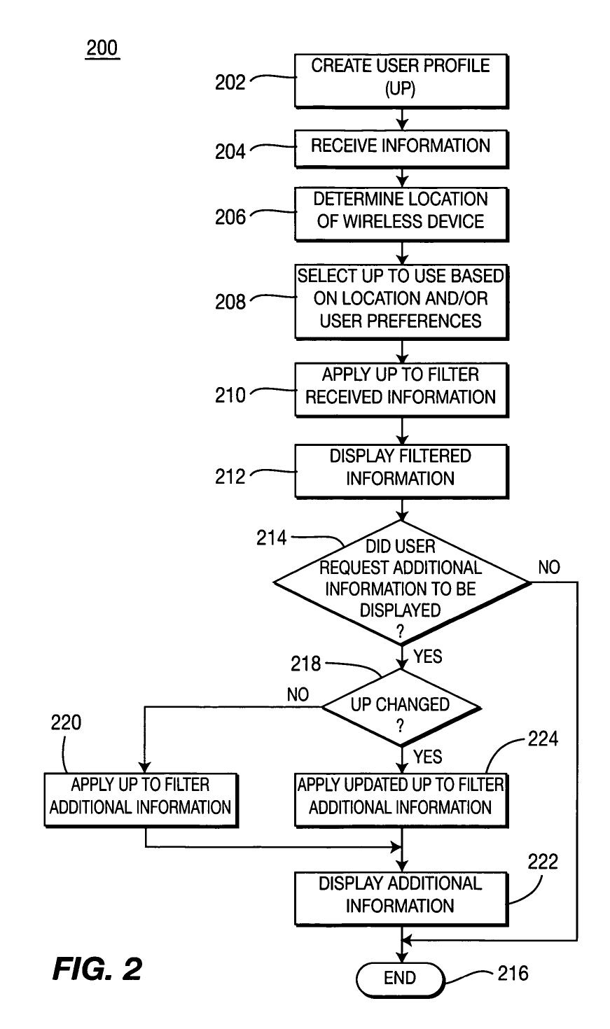

FIG. 2 is a flowchart of a method 200 for filtering information based on a user profile. The method 200 begins by creating a user profile (UP) at a wireless device of the user (step 202). The wireless device receives information desired by the user (step 204). The location of the wireless device is determined (step 206) and the UP to be used is selected based on the location of the wireless device and/or the user's preferences (step 208). Activating a profile creates an elided information tree that accentuates information based on the currently active profile and hides all other information details. Only part of the user's profile is activated depending on the context the user is in and information is exchanged based on the currently active profile. The other parts of the profile are not used, and are kept secret and “elided”.

An information presentation entity (IPE) applies the UP to filter the received information (step 210). The IPE is a layered parsing and filtering entity. All information is passed through the IPE before presenting it to the user. The IPE selects the appropriate filter templates to pass the information through to create context aware, location based, preference aware, and timely information packets. The output at this stage is the information content the user wishes to know at any instant.

The filtered information is then displayed to the user (step 212). When viewing the filtered information, the user can request that additional information relating to the displayed information be shown (step 214). If the user does not request additional information, then the method terminates (step 216).

If the user does request additional information (step 214), a determination is made whether the UP has been changed (step 218). As noted above, the UP can change based on the user moving to a different location or the user selecting a different UP after the information has been displayed. If the UP has not changed, then the existing UP is applied to filter the additional information (step 220). The additional information is displayed (step 222) and the method terminates (step 216). If the UP has changed (step 218), then the updated UP is applied to filter the additional information (step 224). The additional information is displayed (step 222) and the method terminates (step 216).

To illustrate operation of the user profile 100 and the method 200, consider the following example, in which the user profile 100 has two nodes. One node is related to the user's personal information and the other node contains the user's work identity and role. When the user enters his work area (step 206), his profile node containing the work identity is activated (step 208) and is used as a filter (step 210) for information to be delivered. For example, if the user works at a financial institution, he receives a news clip about a company he is following (step 212). Or, if the user works in a IT company, he can receive particular technical news (step 212). At the end of the day when the user returns home (step 206), the work profile is deactivated and the personal profile is activated (step 208). With the personal profile active, an SMS from a friend might be delivered (step 212), but a call from work might be diverted to a voice mail system. In general, information intended for the user that is filtered out by the currently active profile is not discarded, but is retained on the appropriate server for later delivery when the appropriate profile is active. The user may receive a notification in the active profile that information has been received in an inactive profile.

As another example, the entire information content may not be presentable to the user at all times. If the user is at a bus station and has only a PDA, then the entire information content may not be viewable on the PDA or the user may not want to see the entire information content while at the bus station (steps 206, 208). The location and presentation filters (that are part of the currently active profile) have to be applied before the information is presented to the user (step 210). In this example, the resulting presentation of a news report of a Caltech versus Berkeley basketball game would be a headline only (“Caltech defeats Berkeley 105-95”) instead of a three-column article reporting the highlights of the game (step 212). If the user desires to do so, he can click on a “more information” button that will provide some key details of the game, or the user can press a “full report” key to download the entire game report to his PDA (step 214). The user can also provide one-time commands like “show all reports of this game” or “show video commentary or game” and the IPE parses the information tree to extract the requested information to be presented to the user.

The PUP tree can be created from a currently available persistent database or created using smart distributed and personalized databases. Creation of the PUP can include collecting information from different data sources and assembling the information together. Possible data sources include an e-mail server, a calendar, an LDAP server, the user's location, proximity information for the user, information provided by user while registering, etc. In one embodiment, the PUP tree can be built using XML schema, with the tree being filled in by accessing information from the different data sources.

The PUP supports the creation of role-based filters. Role-based filters can be created by modifying a generic role template. Thus, a user can create a personal template, family template, a contacts template, and various other templates to suit the user's requirements. Each of these templates includes a security sub-profile, membership sub-profile, a membership access sub-profile, a membership authority sub-profile, an information exchange sub-profile, a preference sub-profile, an accessibility sub-profile, and other sub-profiles as necessary. The various sub-profiles are required, because it cannot be predicted in advance the situation or role that the user will be in at a given time. In order to be more fully adaptive to the user's changing information needs, the templates are based on a role that the user might assume at different points in time. The templates can be standardized and created in advance, or the user can create custom templates.

An example of a role-based template is a “travel profile” and is shown in FIG. 3 as part of a user profile 300. The user profile 300 includes a plurality of individual profiles 302, global preferences 304, a calendar 306, environment settings 308, and an extensible part 310. A plurality of role-based templates 312 exists, and can include standardized templates, user-created templates, or a combination of both. For example, a user can create many personalized templates like business travel, personal travel, and group travel.

A “business travel” profile 314 is selected by the user and is attached to the extensible part 310. Attaching the business travel profile 314 automatically depends the appropriate sub-profiles, such as hotel preferences 316, air travel preferences 318, and car preferences 320. These sub-profiles need not be unique, and may be linked to already available travel services. Specialization filters can populate a travel service's reservation system with the preferences 316, 318, 320 specified by the user. On the day of travel, the user's profile can automatically confirm his arrival at the travel point, verify seat and booking preferences, and attempt to obtain an upgrade if sub-optimal booking was made at the time of reservation and better arrangements are currently available.

Invoking a role-based template and a sub-profile can be based on manual triggers or automatic triggers. The user can manually trigger a template through an interface on the user's device. Automatic triggers can be based on calendar information, for example. For automatic triggers, an autonomous software agent called a “user agent” can monitor the user's calendar or receive reminders sent by the calendar about the schedule. On receiving the trigger, the user agent marks a certain part of the profile as being active and marks another part of the profile as being inactive or hidden.

Intimation can be provided to the users that certain profile-based information has changed, and the intimation filter defines the order and preference of how the changes are displayed. If there is a sudden change in information being used in user's currently selected profile, the user will be informed about the information change and queried whether to incorporate the change into the profile. By incorporating the profile change, the filtering of information may change.

An example where this might occur is when information related to filter criteria exists. The filter criteria would then be expanded to include this related information. For example, if a user at work was receiving information about Company X, information regarding other companies would be filtered out. However, if Company Z made an announcement in an area relevant to Company X, the user would be altered to the Company Z announcement and prompted whether he wants to expand the filtering to include information about Company Z and the announcement. If the user agrees to expanding the filter, then information relating to Company Z and the announcement would begin reaching the user.

The user also has a choice of forwarding the received information to a group of contacts, which results in chaining the relevant sub-tree link to the PUP trees of his contacts. Each contact receives this information based on the profiles he or she has configured on their device.

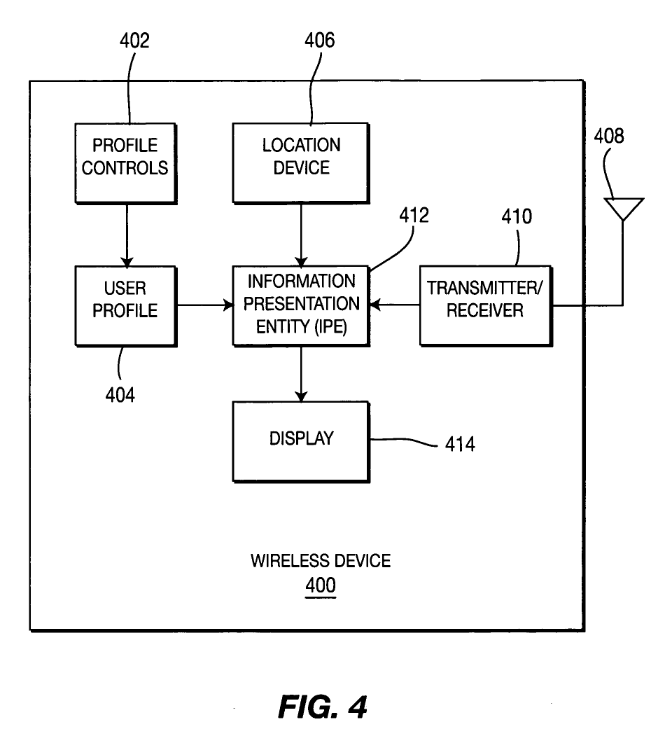

FIG. 4 is a block diagram of a wireless device 400 for filtering information based on a user profile. The wireless device 400 includes profile controls 402 which are used to create a UP 404 and to select the currently applied UP. A location device 406 is used to determine the location of the wireless device 400, and can include any conventional location determining device. An antenna 408 is connected to a receiver 410 for receiving information from a network. An IPE 412 coordinates the UP 404, the location information from the location device 406, and the information received from the receiver 410. The IPE 412 filters the information and sends the filtered information to a display 414 for viewing by the user.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for distributing information to a user of an information system via a device, the method comprising the steps of:
selecting a user profile;
receiving information at the device;
filtering the information with the selected user profile; and
displaying the filtered information to the user.

2. The method according to claim 1, wherein the selecting step includes selecting a user profile based on user preferences.

3. The method according to claim 1, further comprising the step of:
creating at least one user profile.

4. The method according to claim 1, further comprising the step of:
determining a location of the user's device.

5. The method according to claim 4, wherein the selecting step includes selecting a user profile based on the location of the device.

6. The method according to claim 4, wherein the selecting step includes selecting a user profile based on user preferences and the location of the device.

7. The method according to claim 1, further comprising the steps of:
determining whether the user requested additional information to be displayed, the additional information relating to the filtered information;
filtering the additional information with the selected user profile; and
displaying the additional information.

8. The method according to claim 7, further comprising the steps of:
determining whether the user profile has changed;
filtering the additional information with the changed user profile; and
displaying the additional information.

9. A wireless device for distributing information to a user of an information system, comprising:
at least one user profile;
a receiver, configured to receive information from the information system;
an information processing entity (IPE), configured to select a user profile and to filter the received information with the selected user profile; and
a display, configured to display the filtered information to the user.

10. The wireless device according to claim 9, wherein said IPE is configured to select a user profile based on user preferences.

11. The wireless device according to claim 9, further comprising:
a profile device configured to manage said at least one user profile.

12. The wireless device according to claim 11, wherein said profile device is further configured to create a user profile.

13. The wireless device according to claim 9, further comprising:
a location device, configured to determine the location of the wireless device.

14. The wireless device according to claim 13, wherein said IPE is configured to select a user profile based on the location of the wireless device.

15. The wireless device according to claim 13, wherein said IPE is configured to select a user profile based on user preferences and the location of the wireless device.

16. The wireless device according to claim 9, wherein said IPE is further configured to:
determine whether the user has requested additional information, the additional information relating to the filtered information;
filter the additional information with the selected user profile; and
display the additional information.

17. The wireless device according to claim 16, wherein said IPE is further configured to:
determine whether the selected user profile has changed;
filter the additional information with the changed user profile; and
display the additional information.
